(19) United States
(12) Patent Application Publication
(10) Pub. No.: US 2005/0288309 A1
(43) Pub. Date: Dec. 29, 2005

(54) Fungicidal mixtures

(76) Inventors: Jordi Totmo i Blasco, Laudenbach (DE); Thomas Grote, Wachenheim (DE); Eberhard Ammermann, Heppenheim (DE); Reinhard Stierl, Freinsheim (DE); Siegfried Strathmann, Limburgerhof (DE); Ulrich Schofl, Bruhl (DE)

Correspondence Address: BIRCH STEWART KOLASCH & BIRCH, PO BOX 747, FALLS CHURCH, VA, 22040-0747, US

(21) Appl. No.: 10/532,756

(22) PCT Filed: Nov. 14, 2003
(86) PCT No.: PCT/EP03/12768

§ 371 Date: Apr. 27, 2005

(30) Foreign Application Priority Data
Nov. 15, 2002 (DE) 102 53 583.3

(51) Int. Cl. A01N 43/90; A01N 43/56

(52) U.S. Cl. 514/259.31; 514/406

(57) ABSTRACT

Fungicidal mixtures comprising
A) the triazolopyrimidine derivative of the formula I 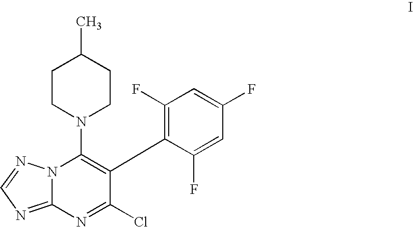 and
B) carbamates of the formula II 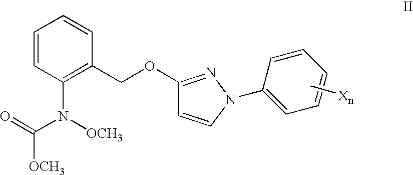 in which n is 1 or 2 and X is halogen, alkyl or haloalkyl, where the radicals X may be different if n is 2, in a synergistically effective amount, methods for controlling harmful fungi using mixtures of the compounds I and II, compositions comprising these compounds and the use of the compounds I and the compounds II for preparing such mixtures are described.

The present invention relates to fungicidal mixtures, comprising
A) the triazolopyrimidine derivative of the formula I 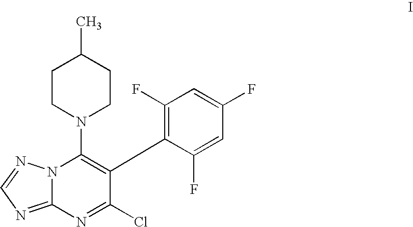
   and
B) carbamates of the formula II 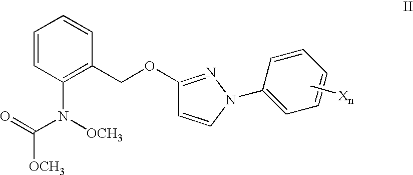
   in which n is 1 or 2 and X is halogen, C₁-C₄-alkyl or C₁-C₂-haloalkyl, where the radicals X may be different if n is 2,
in a synergistically effective amount.

Moreover, the invention relates to methods for controlling harmful fungi using mixtures of the compounds I and II, to compositions comprising these compounds and to the use of the compounds I and the compounds II for preparing such mixtures.

The compound of the formula I, 5-chloro-7-(4-methylpiperidin-1-yl)-6-(2,4,6-trifluorophenyl)-[1,2,4]triazolo[1,5-a]- pyrimidine, its preparation and its action against harmful fungi are known from the literature (WO 98/46607).

Carbamates of the formula II belong to the class of the active strobilurin compounds. Their preparation and their action against harmful fungi are likewise known (WO 93/15046 and WO 96/01256).

Mixtures of triazolopyrimidines with strobilurin derivatives are known in a general manner from EP-A 988 790. The compounds I and II are embraced by the general disclosure of this publication; however, neither the triazolopyrimidine of the formula I nor carbamates of the formula II are mentioned in EP-A 988 790.

Mixtures of the carbamates II with other active compounds are likewise known (WO 97/40673, WO 97/40676, WO 97/40684).

The fungicidal activity of the known mixtures is not always entirely satisfactory. The active triazolopyrimidine compounds known from EP-A 988 790, for example, are of limited suitability for controlling harmful fungi from the classes of the Oomycetes. The activity of the carbamates II against Oomycetes does likewise not meet today's requirements.

It was an object of the present invention, with a view to reducing the application rates and broadening the activity spectrum, to provide mixtures which, at a reduced total amount of active compounds applied, have improved activity against harmful fungi, in particular against those from the class of the Oomycetes (synergistic mixtures).

We have found that this object is achieved by the mixtures defined at the outset. Moreover, we have found that simultaneous, that is joint or separate, application of the compounds I and the compounds II or successive application of the compounds I and the compounds II allows better control of harmful fungi than is possible with the individual compounds.

The mixtures of compounds I and II, or the compounds I and II applied simultaneously, that is jointly or separately, act synergistically and are distinguished by excellent activity against a broad spectrum of phytopathogenic fungi, in particular from the classes of the Ascomiycetes, Basidiomycetes, Phycomycetes and Deuteromycetes. Some of them are systemically effective and can therefore also be used as foliar- and soil-acting fungicides.

They are particularly important for contolling a multitude of 40 fungi on various crop plants, such as cotton, vegetables (for example cucumber, beans, tomatoes, potatoes and cucurbits), barley, grass, oats, bananas, coffee, corn, fruit plants, rice, rye, soybeans, grapevines, wheat, ornamentals, sugarcane and a large number of seeds.

They are particularly suitable for controlling the following phytopathogenic fungi: Blumeria graminis (powdery mildew) on cereals, Erysiphe cichoracearum and Sphaerotheca fuliginea on cucurbits, Podosphaera leucotricha on apples, Uncinula necator on grapevines, Puccinia species on cereals, Rhizoctonia species on cotton, rice and grass, Ustilago species on cereals and sugarcane, Venturia inaequalis on apples, Bipolaris- and Drechslera species on cereals, rice and grass, Septoria nodorum on wheat, Botrytis cinerea on strawberries, vegetables, ornamentals and grapevines, Mycosphaerella species on bananas, peanuts and cereals, Pseudocercosporella herpotrichoides on wheat and barley, Pyricularia oryzae on rice, Phytophthora infestans on potatoes and tomatoes, Pseudoperonospora species on cucurbits and hops, Plasmopara viticola on grapevines, Alternaria species on vegetables and fruit, and also Fusarium- and Verticillium species.

The mixtures according to the invention are particularly suitable for controlling harmful fungi from the classes of the Oomycetes and expecially Phytophthora infestans on various vegetable plants and Plasmopara viticola on grapevines.

In addition, they are particularly advantageously suitable for controlling powdery and downy mildew fungi in cereals, vegetables, fruit, ornamentals and grapevines.

Moreover, they can be used in the protection of materials (for example the protection of wood), for example against Paecilomyces variotii.

The formula II represents in partciular carbamates in which the combination of the substituents corresponds to one row of the table below:

| | |
|---|---|
| | II |
| 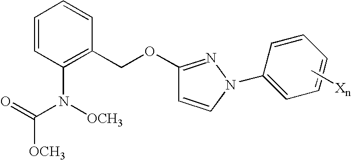 | |

| No. | Xₙ |
|---|---|
| II-1 | 2-F |
| II-2 | 3-F |
| II-3 | 4-F |
| II-4 | 2-Cl |
| II-5 | 3-Cl |
| II-6 | 4-Cl |
| II-7 | 2-Br |
| II-8 | 3-Br |
| II-9 | 4-Br |
| II-10 | 2-CH₃ |
| II-11 | 3-CH₃ |
| II-12 | 4-CH₃ |
| II-13 | 2-CF₃ |
| II-14 | 3-CF₃ |
| II-15 | 4-CF₃ |
| II-16 | 2,4-F₂ |
| II-17 | 2,4-Cl₂ |
| II-18 | 3,4-Cl₂ |
| II-19 | 2-Cl, 4-CH₃ |
| II-20 | 3-Cl, 4-CH₃ |

Preference is given to compounds of the formula II in which X is fluorine, chlorine or methyl and is located in the para-position; these compounds are described by the formula IIa:

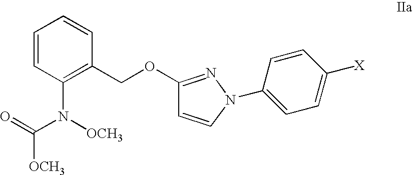

Preference is given to compounds of the formula IIa in which X is fluorine, chlorine, methyl or trifluoromethyl. Particular preference is given to the compounds II-3, II-6, II-12 and II-17, in particular II-6 (common name: pyraclostrobin).

Owing to the basic character of their nitrogen atoms, the compounds I and II are capable of forming salts or adducts with inorganic or organic acids or with metal ions.

Examples of inorganic acids are hydrohalic acids, such as hydrogen fluoride, hydrogen chloride, hydrogen bromide and hydrogen iodide, sulfuric acid, phosphoric acid and nitric acid.

Suitable organic acids are, for example, formic acid, carbonic acid and alkanoic acids, such as acetic acid, trifluoroacetic acid, trichloroacetic acid and propionic acid, and also glycolic acid, lactic acid, succinic acid, citric acid, benzoic acid, cinnamic acid, oxalic acid, p-toluenesulfonic acid, salicylic acid, p-aminosalicylic acid, 2-phenoxybenzoic acid or 2-acetoxybenzoic acid.

Suitable metal ions are in particular the ions of the elements of the first to eighth transition group, especially chromium, manganese, iron, cobalt, nickel, copper, zinc, and additionally those of the second main group, especially calcium and magnesium, and of the third and fourth main group, in particular aluminum, tin and lead. If appropriate, the metals can be present in the different valencies that they can assume.

When preparing the mixtures, it is preferred to employ the pure active compounds I and II, to which further active compounds against harmful fungi or against other pests, such as insects, arachnids or nematodes, or else herbicidal or growth-regulating active compounds or fertilizers can be added.

The compounds I and II can be applied simultaneously, that is jointly or separately, or in succession, the sequence, in the case of separate application, generally not having any effect on the result of the control measures.

The compounds I and II are usually applied in a weight ratio of from 100:1 to 1:100, in particular from 20:1 to 1:20, preferably from 10:1 to 1:10.

Depending on the desired effect, the application rates of the mixtures according to the invention are, especially in the case of areas under agricultural cultivation, from 5 to 2 000 g/ha, preferably from 50 to 1 500 g/ha, in particular from 50 to 750 g/ha.

Here, the application rates of the compound I are from 1 g to 1 kg/ha, preferably from 10 to 900 g/ha, in particular from 20 to 750 g/ha.

Correspondingly, the application rates of the compounds II are from 1 g to 1 kg/ha, preferably from 10 to 750 g/ha, in particular from 20 to 500 g/ha.

In the treatment of seed, the application rates of the mixture are generally from 0.1 to 1 000 g/100 kg of seed, preferably from 0.1 to 200 g/100 kg, in particular from 1 to 100 g/100 kg.

In the control of phytopathogenic harmful fungi, the separate or joint application of the compounds I and II or of the mixtures of the compounds I and II is carried out by spraying or dusting the seeds, the plants or the soils before or after sowing of the plants or before or after emergence of the plants.

The fungicidal synergistic mixtures according to the invention, or the compounds I and II, can be prepared, for example, in the form of directly sprayable solutions, powders and suspensions or in the form of highly concentrated aqueous, oily or other suspensions, dispersions, emulsions, oil dispersions, pastes, dusts, compositions for spreading or granules, and be applied by spraying, atomizing, dusting, broadcasting or watering. The use form depends on the particular purpose; in each case, it should ensure a distribution of the mixture according to the invention which is as fine and uniform as possible.

The formulations are prepared in a known manner, for example by extending the active compound with solvents and/or carriers, if desired using emulsifiers and dispersants. Solvents/auxiliaries which are suitable are essentially:
water, aromatic solvents (for example Solvesso products, xylene), paraffins (for example mineral fractions), alcohols (for example methanol, butanol, pentanol, benzyl alcohol), ketones (for example cyclohexanone, gamma-butyrolactone), pyrrolidones (NMP, NOP), acetates (glycol diacetate), glycols, fatty acid dimethylamides, fatty acids and fatty acid esters. In principle, solvent mixtures may also be used,
carriers such as ground natural minerals (for example kaolins, clays, talc, chalk) and ground synthetic minerals (for example highly disperse silica, silicates); emulsifiers such as nonionic and anionic emulsifiers (for example polyoxyethylene fatty alcohol ethers, alkylsulfonates and arylsulfonates) and dispersants such as lignin-sulfite waste liquors and methylcellulose.

Suitable surfactants are alkali metal, alkaline earth metal and ammonium salts of lignosulfonic acid, naphthalenesulfonic acid, phenolsulfonic acid, dibutylnaphthalenesulfonic acid, alkylarylsulfonates, alkyl sulfates, alkylsulfonates, fatty alcohol sulfates, fatty acids and sulfated fatty alcohol glycol ethers, furthermore condensates of sulfonated naphthalene and naphthalene derivatives with formaldehyde, condensates of naphthalene or of naphthalenesulfonic acid with phenol and formaldehyde, polyoxyethylene octylphenyl ether, ethoxylated isooctylphenol, octylphenol, nonylphenol, alkylphenyl polyglycol ethers, tributylphenyl polyglycol ether, tristearylphenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignosulfite waste liquors and methylcellulose.

Substances which are suitable for the preparation of directly sprayable solutions, emulsions, pastes or oil dispersions are mineral oil fractions of medium to high boiling point, such as kerosene or diesel oil, furthermore coal tar oils and oils of vegetable or animal origin, aliphatic, cyclic and aromatic hydrocarbons, for example toluene, xylene, paraffin, tetrahydronaphthalene, alkylated naphthalenes or their derivatives, methanol, ethanol, propanol, butanol, cyclohexanol, cyclohexanone, isophorone, strongly polar solvents, for example dimethyl sulfoxide, N-methylpyrrolidone and water.

Powders, materials for spreading and dustable products can be prepared by mixing or concomitantly grinding the active substances with a solid carrier.

Granules, for example coated granules, impregnated granules and homogeneous granules, can be prepared by binding the active compounds to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, for example, ammonium sulfate, ammonium phosphate, ammonium nitrate, ureas, and products of vegetable origin, such as cereal meal, tree bark meal, wood meal and nutshell meal, cellulose powders and other solid carriers.

In general, the formulations comprise from 0.01 to 95% by weight, preferably from 0.1 to 90% by weight, of the active compounds. The active compounds are employed in a purity of from 90% to 100%, preferably 95% to 100% (according to NMR spectrum).

The following are examples of formulations: 1. Products for dilution with water

A) Water-Soluble Concentrates (SL)

10 parts by weight of the active compounds are dissolved in water or in a water-soluble solvent. As an alternative, wetters or other auxiliaries are added. The active compound dissolves upon dilution with water.

B) Dispersible Concentrates (DC)

20 parts by weight of the active compounds are dissolved in cyclohexanone with addition of a dispersant, for example polyvinylpyrrolidone. Dilution with water gives a dispersion.

C) Emulsifiable Concentrates (EC)

15 parts by weight of the active compounds are dissolved in xylene with addition of calcium dodecylbenzenesulfonate and castor oil ethoxylate (in each case 5% strength). Dilution with water gives an emulsion.

D) Emulsions (EW, EO)

40 parts by weight of the active compounds are dissolved in xylene with addition of calcium dodecylbenzenesulfonate and castor oil ethoxylate (in each case 5% strength). This mixture is introduced into water by means of an emulsifier machine (Ultraturvax) and made into a homogeneous emulsion. Dilution with water gives an emulsion.

E) Suspensions (SC, OD)

In an agitated ball mill, 20 parts by weight of the active compounds are comminuted with addition of dispersant, wetters and water or an organic solvent to give a fine active compound suspension. Dilution with water gives a stable suspension of the active compound.

F) Water-Dispersible Granules and Water-Soluble Granules (WG, SG)

50 parts by weight of the active compounds are ground finely with addition of dispersants and wetters and made into water-dispersible or water-soluble granules by means of technical appliances (for example extrusion, spray tower, fluidized bed). Dilution with water gives a stable dispersion or solution of the active compound.

G) Water-Dispersible Powders and Water-Soluble Powders (WP, SP)

75 parts by weight of the active compounds are ground in a rotor-stator mill with addition of dispersant, wetters and silica gel. Dilution in water gives a stable dispersion or solution with the active compound.

2. Products to be Applied Undiluted

H) Dustable Powders (DP)

5 parts by weight of the active compounds are ground finely and mixed intimately with 95% of finely divided kaolin. This gives a dustable product.

I) Granules (GR, FG, GG, MG)

0.5 part by weight of the active compounds is ground finely and associated with 95.5% carriers. Current methods are extrusion, spray-drying or the fluidized bed. This gives granules to be applied undiluted.

J) ULV Solutions (UL)

10 parts by weight of the active compounds are dissolved in an organic solvent, for example xylene. This gives a product to be applied undiluted.

The active compounds can be used as such, in the form of their formulations or the use forms prepared therefrom, for example in the form of directly sprayable solutions, powders, suspensions or dispersions, emulsions, oil dispersions, pastes, dustable products, materials for spreading, or granules, by means of spraying, atomizing, dusting, spreading or pouring. The use forms depend entirely on the intended purposes; it is intended to ensure in each case the finest possible distribution of the active compounds according to the invention.

Aqueous use forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active compound concentrations in the ready-to-use preparations can be varied within relatively wide ranges. In general, they are from 0.0001 to 10%, preferably from 0.01 to 1%.

The active compounds may also be used successfully in the ultra-low-volume process (ULV), it being possible to apply formulations comprising over 95% by weight of active compound, or even to apply the active compound without additives.

Various types of oils, wetters, adjuvants, herbicides, fungicides, other pesticides, or bactericides may be added to the active compounds, if appropriate just immediately prior to use (tank mix). These agents can be admixed with the agents according to the invention in a weight ratio of 1:10 to 10:1.

The compounds I or II, the mixtures or the corresponding formulations are applied by treating the harmful fungi, their habitat or the plants, seeds, soils, areas, materials or spaces to be kept free from them with a fungicidally effective amount of the mixture or, in the case of separate application, of the compounds I and II.

Application can be carried out before or after infection by harmful fungi.

### USE EXAMPLE

The synergistic action of the mixtures according to the invention was demonstrated by the following experiments:

The active compounds, separately or jointly, were prepared as a 10% emulsion in a mixture of 63% by weight of cyclohexanone and 27% by weight of emulsifier and diluted with water to the desired concentration.

Evaluation was carried out by determining the infected leaf areas in percent. These percentages were converted into efficacies. The efficacy (E) is calculated as follows using Abbot's formula:
E=(1α/β)·100
α corresponds to the fungicidal infection of the treated plants in % and
β corresponds to the fungicidal infection of the untreated (control) plants in %

An efficacy of 0 means that the infection level of the treated plants corresponds to that of the untreated control plants; an efficacy of 100 means that the treated plants were not infected.

The expected efficacies of the mixtures of active compounds are determined using Colby's formula [R. S. Colby, Weeds 15, 20-22 (1967)] and compared with the observed efficacies.

Colby's formula:
E=x+y−x·y/100
E expected efficacy, expressed in % of the untreated control, when using the mixture of the active compounds A and B at the concentrations a and b
x efficacy, expressed in % of the untreated control, when using active compound A at the concentration a
y efficacy, expressed in % of the untreated control, when using active compound B at the concentration b

### Use Example

### Activity against Peronospora of Grapevines caused by Plasmopara viticola

Leaves of potted vines of the cultivar “Müller-Thurgau” were sprayed to runoff point with an aqueous suspension having the concentration of active compound stated below. The suspension or emulsion was prepared from a stock solution comprising 10% of active compound in a mixture consisting of 70% of cyclohexanone, 20% of wetting agent and 10% of emulsifier. The next day, the undersides of the leaves were inoculated with an aqueous zoospore suspension of Plasmopara viticola. The grapevines were then initially placed in a water-vapor-saturated chamber at 24° C. for 48 hours and then in a greenhouse at 20-30° C. for 5 days. After this period of time, the plants were again placed in a humid chamber for 16 hours to promote sporangiophore eruption. The extent of the development of the disease on the undersides of the leaves was then determined visually.

TABLE A
individual active compounds

| | | Concentration in | Efficacy in % of |
|---|---|---|---|
| Experiment | | the spray liquor | the untreated |
| No. | Active compound | [ppm] | control |
| 1 | Control | (70% infection) | — |
| | (untreated) | | |
| 2 | I | 4 | 29 |
| | | 1 | 0 |
| | | 0.25 | 0 |
| 3 | II-6 | 1 | 29 |
| | (pyraclostrobin) | | |

TABLE B
combinations according to the invention

| | Mixture of active | | |
|---|---|---|---|
| | compounds | | |
| Experiment | Concentration | Observed | Calculated |
| No. | Mixing ratio | efficacy | efficacy*) |
| 4 | I + II-6 | 100 | 49 |
| | 4 + 1 ppm | | |
| | 4:1 | | |
| 5 | I + II-6 | 100 | 29 |
| | 1 + 1 ppm | | |
| | 1:1 | | |
| 6 | I + II-6 | 100 | 29 |
| | 0.25 + 1 ppm | | |
| | 1:4 | | |

*)efficacy calculated using Colby's formula

The test results show that in all mixing ratios the observed efficacy of the mixtures according to the invention is higher than that calculated beforehand using Colby's formula.

1. A fungicidal mixture, comprising
A) the triazolopyrimidine derivative of the formula I 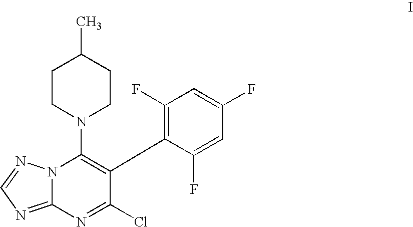
B) carbamates of the formula II 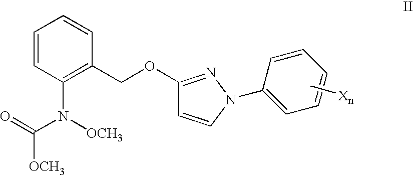
in which n is 1 or 2 and X is halogen, C₁-C₄-alkyl or C₁-C₂-haloalkyl, where the radicals X may be different if n is 2, in a synergistically effective amount.

2. A fungicidal mixture as claimed in claim 1, where the carbamate II corresponds to formula IIa 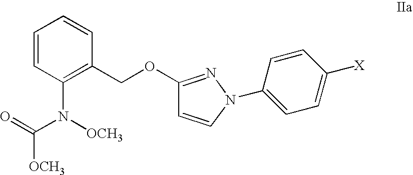
in which X is fluorine, chlorine or methyl.

3. A fungicidal mixture as claimed in claim 1, comprising, as carbamate II, the compound II-6.

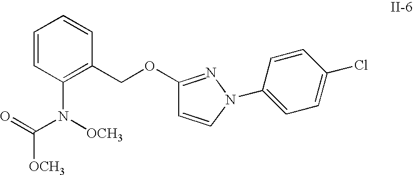

4. A fungicidal mixture as claimed in claim 1, wherein the weight ratio of the triazolopyrimidine I to the carbamates of the formula II is from 100:1 to 1:100.

5. A fungicidal composition, comprising the fungicidal mixture as claimed in claim 1, and a solid or liquid carrier.

6. A method for controlling phytopathogenic harmful fungi, which comprises treating the harmful fungi, their habitat or the plants, seeds, soils, areas, materials or spaces to be kept free from them with the triazolopyrimidine derivative of the formula I as set forth in claim 1 and carbamates of the formula II as set forth in claim 1.

7. A method as claimed in claim 6, wherein the triazolopyrimidine derivative of the formula I as set forth in claim 1 and carbamates of the formula II as set forth in claim 1 are applied simultaneously, that is jointly or separately, or in succession.

8. A method as claimed in claim 6, wherein the mixture as claimed in claim 1 is applied in an amount of from 5 g/ha to 2 000 g/ha.

9. A method as claimed in claim 6, wherein the mixture as claimed in claim 1 is applied in an amount of from 1 to 1 000 g/100 kg of seed.

10. Seed, comprising the mixture as claimed in claim 1 in an amount of from 1 to 1 000 g/100 kg.

11. The use of the compounds I and II as set forth in claim 1 for preparing a composition suitable for controlling harmful fungi.
